(19) United States
(12) Patent Application Publication
(10) Pub. No.: US 2011/0253280 A1
(43) Pub. Date: Oct. 20, 2011

(54) STEEL CORD FOR REINFORCING RUBBER ARTICLES AND PNEUMATIC TIRE USING THE SAME

(75) Inventor: Hiroyuki Matsuo, Kodaira-shi (JP)

(73) Assignee: BRIDGESTONE CORPORATION, Chuo-ku, Tokyo (JP)

(21) Appl. No.: 13/141,245

(22) PCT Filed: Dec. 22, 2009
(86) PCT No.: PCT/JP2009/007150

§ 371 Date: Jun. 21, 2011

(30) Foreign Application Priority Data
Dec. 22, 2008 (JP) 2008-326593

(51) Int. Cl. B60C 9/18; D02G 3/00; B60C 9/16

(52) U.S. Cl. 152/526; 428/364

(57) ABSTRACT

A steel cord for reinforcing rubber articles in which sheath wires are not deviated and which has an excellent rubber penetration property and a tire which has an excellent durability using the steel cord is provided.

A steel cord for reinforcing rubber articles composed of a core 10 composed of two untwisted steel wires 1 and six sheath wires 2 which are twisted around the core 10 is disclosed. The average of gap distances between the adjacent sheath wires 2 is 24 μm or larger, and the occupancy of the sheath wires 6 disposed around the core 10 with respect to a sheath wire disposition area is 80% or larger. A pneumatic tire in which the steel cord is applied on both a carcass and (a) belt layer(s) or applied on either the carcass or the belt layer(s) is also disclosed.

### TECHNICAL FIELD

The present invention relates to a steel cord for reinforcing rubber articles (hereinafter, also simply referred to as “steel cord”) and a pneumatic tire using the steel cord (hereinafter, also simply referred to as “tire”), and more particularly, to a steel cord having a 2+6 structure for reinforcing rubber articles in which sheath wires are not deviated and which has an excellent rubber penetration (hereinafter, also simply referred to as “rubber penetration”) property and a tire which has an excellent durability using the steel cord.

### BACKGROUND ART

In a pneumatic tire which is a typical example of rubber articles, as a cause of decreasing the durability of the tire, a separation is known which is generated in such a way that water which is penetrated into an internal belt or the like from the outside of the tire through a cut-flaw or the like corrodes cords of the belt, and the cords are separated from the rubber because of expansion of the corroded area.

In order to avoid the separation, a so-called rubber penetration structure is effective in which gaps between wires of the cord where water spreads are not to be formed by making rubber sufficiently penetrate into the inside of the cords. This rubber penetration structure attains rubber penetration by expanding the gaps between the wires by loosely twisting the cords.

For example, Patent Document 1 discloses a steal cord having a core composed of two untwisted steel wires, and five to eight sheath wires having a diameter of 0.8 to 1.2 times the diameter of the core wires which are wound around the core at a sheath interval of 0.02 to 0.25 mm. Patent Document 2 discloses a steel cord having a 2+6 structure in which the twist pitch of a core composed of two steel wires is 30 mm or larger, the diameter of six sheath wires is larger than 58.0% and smaller than 161.15% of the diameter of the core wire, and the diameter of the sheath wire is 0.10 mm to 0.30 mm. Patent Document 3 discloses a steel cord composed of steel wires in which a core is composed of two untwisted steel wires, the diameter of the core wire is 0.25 mm to 0.40 mm, and the diameter of a sheath wire is such that (0.75×diameter of core wire−0.5×diameter of sheath wire) is in the range of 0.05 to 0.10. Further, Patent Document 4 discloses a steel cord which is composed of a core composed of two twisted steel wires and five to seven sheath wires, in which 0.05 mm≦diameter of core wire<0.26 mm, 0.05 mm≦diameter of sheath wire<0.26 mm, and 0.7<diameter of core wire/ diameter of sheath wire<1.

### RELATED ART DOCUMENT

### Patent Document

Patent Document 1: Japanese Unexamined Patent Application Publication No. H09-156314

Patent Document 2: Japanese Unexamined Patent Application Publication No. H09-158066

Patent Document 3: Japanese Unexamined Patent Application Publication No. H11-81168

Patent Document 4: Japanese Unexamined Patent Application Publication No. 2007-063724

### SUMMARY OF THE INVENTION

### Problems to be solved by the Invention

However, it is known that, in a steel cord having a 2+6 structure, when the gaps between sheath wires are too large, the dispersity of the sheath wires deviates, and when the gaps between sheath wires are small, rubber penetration will not occur. That is, in the steel cords described in Patent Documents 1 and 3, the gaps between the sheath wires are too large and the dispersity of the sheath wires deviates. In the steel cords described in Patent Documents 2, when the upper limit of the diameter of the core wire is employed, the gaps between sheath wires are too large and the dispersity of the sheath wires deviates, and on the other hand, when the lower limit of the diameter of the core wire is employed, the gaps between sheath wires are small and rubber penetration will not occur. In the steel cords described in Patent Documents 4, when the upper limit of the diameter of the core wire is employed, the gaps between sheath wires are too large and the dispersity of the sheath wires deviates. That is, it is quite difficult for the conventional steel cords to balance the deviation of the sheath wires with rubber penetration property.

Accordingly, an object of the present invention is to provide a steel cord having a 2+6 structure for reinforcing rubber articles in which sheath wires are not deviated and which has an excellent rubber penetration property and a pneumatic tire which has an excellent durability using the steel cord.

### Means for solving the Problems

In order to solve the above problems, the present inventor intensively studied to find out that the above problems can be solved by defining, in a steel cord having a 2+6 structure, the relation between the diameter of the core wire and the diameter of the sheath wire as described below, thereby completing the present invention.

That is, the steel cord for reinforcing rubber articles of the present invention is a steel cord for reinforcing rubber articles composed of a core composed of two untwisted steel wires and six sheath wires which are twisted around the core, wherein

the average of gap distances between the adjacent sheath wires is 24 μm or larger, and the occupancy of the sheath wires disposed around the core with respect to a sheath wire disposition area is 80% or larger.

In the present invention, the occupancy of the sheath wires is preferably 84% or larger.

The pneumatic tire of the present invention is a pneumatic tire which has, as a skeleton, a carcass extending toroidally between a pair of beads, and in which the crown portion of the carcass is reinforced by (a) belt layer(s), characterized in that

the steel cord for reinforcing rubber articles is applied as a cord which constitutes the carcass and/or the belt layer(s).

### Effects of the Invention

By the present invention, a steel cord having a 2+6 structure for reinforcing rubber articles in which sheath wires are not deviated and which has an excellent rubber penetration property and a tire which has an excellent durability using the steel cord can be provided.

### BRIEF DESCRIPTION OF THE DRAWINGS

FIG. 1 is a cross-sectional view of a steel cord of one embodiment of the present invention.

FIG. 2 is a graph showing the relation between the average gap distance of sheath wires and the rubber penetration property.

FIG. 3 is a graph showing the relation between the tension applied to sheath wires when the sheath wires are twisted and the deviation of sheath wire gaps.

FIG. 4 is a schematic diagram of the deviation of the sheath wire gaps.

### MODES FOR CARRYING OUT THE INVENTION

Preferred modes of the present invention will now be described in detail with reference to the drawings.

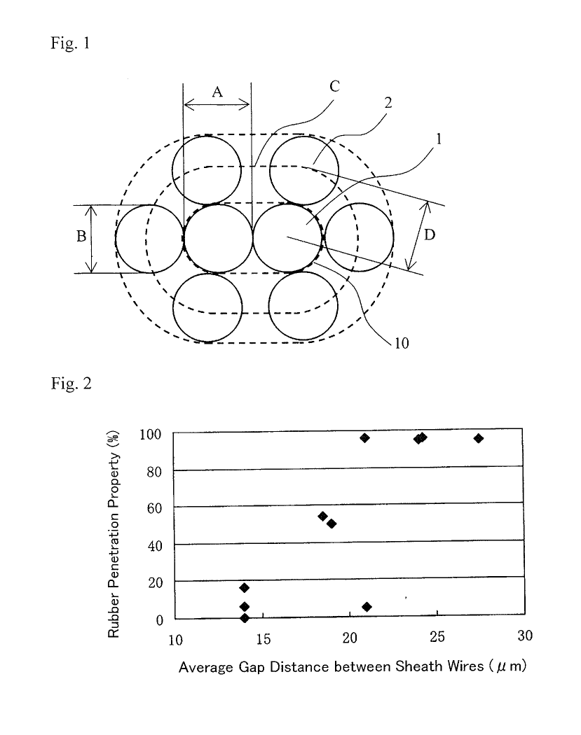

FIG. 1 shows a cross-sectional structure diagram of a steel cord of one preferred embodiment of the present invention. The illustrated steel cord is composed of a core 10 composed of two untwisted core wires 1 and six sheath wires 2 which are twisted around the core 10. Here, letting a trajectory drawn at the position the radius of the sheath wire away from the core 10 be a circumference C, the length of the circumference C (mm) can be represented by

C(mm)=(2×A)+(2×π×D)

where the diameter of the core wire is A (mm), the diameter of the sheath wire is B (mm), and the radius of a half circle drawn at the ends of the circumference C is D (D=A/2+B/2: mm). Here, the average of gap distances between the adjacent sheath wires 2 (hereinafter, also referred to as “sheath wire gap”) and the occupancy of sheath wire 2 (hereinafter, also referred to as “sheath wire occupancy”) are defined by the following formulae (1) and (2):

The average of sheath wire gaps (μm)=(C−6×B)/6×1000 (1)

Sheath wire occupancy (%)=(6×B)/C×100 (2).

In the present invention, it is important that the average of sheath wire gaps represented by the above formula (1) is 24 μm or larger. FIG. 2 is a graph showing the relation between the average of sheath wire gaps and the rubber penetration, for steel cords with a variety of structures. As shown in the figure, when the average of sheath wire gaps is 24 μm or larger, an excellent rubber penetration property can be obtained. On the other hand, when the average of sheath wire gaps is less than 24 μm, an excellent rubber penetration property cannot be obtained. Based on these discovery, in the present invention, the average of sheath wire gaps of a steel cord was set to 24 μm or larger. In order to favorably obtain the above effect, the average of sheath wire gaps is preferably 30 μm or larger.

In the present invention, it is also important that the sheath wire occupancy represented by the above formula (2) is 80% or larger. As described above, in the present invention, the average of sheath wire gaps needs to be 24 μm or larger. However, when the sheath wire gaps are too large, the sheath wire gaps vary and deviate (see FIG. 4), which is not preferred. Accordingly, the sheath wire occupancy defined in the formula (2) needs to be 80% or larger. In the present invention, in order to favorably obtain the above effects, the sheath wire occupancy is preferably 84% or larger.

In the manufacturing process of the steel cord, it is known that the variation of the tensions of the sheath wires when the steel wires are twisted influences the sheath wire gaps. The larger the variation of the tensions of the sheath wires, the easier the sheath wire gaps deviate. However, there is an effect that the higher the sheath wire occupancy is, the smaller the variation of the sheath wire gaps is.

In the present invention, it is important only that the diameter of the core wire and the diameter of the sheath wire meet the above requirements. The other requirements such as a specific diameter of each of the wires, the direction of twisting of the sheath wire and the twist pitch are not especially restricted as long as the above conditions are met, and, depending on the applications, they can be appropriately constituted according to a conventional method.

The steel cord for reinforcing rubber articles of the present invention can be favorably used for, for example, a pneumatic tire in which (a) ply(plies) in which a plurality of the cords are oriented in parallel to each other and embedded in a rubber sheet is(are) applied on both a carcass and (a) belt layer(s) or applied on either the carcass or the belt layer(s). Although not illustrated, the pneumatic tire of the present invention is a pneumatic tire in which the above-described steel cord for reinforcing rubber articles of the present invention is applied on the carcass and/or belt layer(s) of the pneumatic tire which has, as a skeleton, a carcass extending toroidally between a pair of beads, and in which the crown portion of the carcass is reinforced by the belt layer(s). By this, a pneumatic tire having an excellent durability can be obtained.

### Examples

The present invention will now be described in detail by way of Examples.

### Examples and Comparative Examples

Steel cords having a 2+6 structure which has the diameter of the core wire, the diameter of the sheath wire, the sheath wire gap and the sheath wire occupancy as shown in the Table 1 below were manufactured by applying the sheath tension as shown in the same table. When each of the steel cords was twisted, the tensions of the respective sheath wires were measured and the variation of the sheath wire tensions as shown in the following formula:

Variation of the sheath wire tensions=Tensionₘₐₓ−Tensionₘᵢₙ

were calculated.

### Rubber Penetration Property

Each of the obtained steel cords was embedded in rubber and rubber-steel cord complexes were manufactured. Thereafter, the entire outer layers (sheath wires) of the obtained rubber-steel cord complexes were removed and the core portions were taken out. The lengths of the portions on which the rubber covered were measured viewed from four directions to calculate the rubber penetration property by the following formula:

(rubber penetration property)=(the length of rubber coverage/the length of the sample)×100 (%).

The obtained results are also shown in table 1.

### Variation of Sheath Wire Gaps

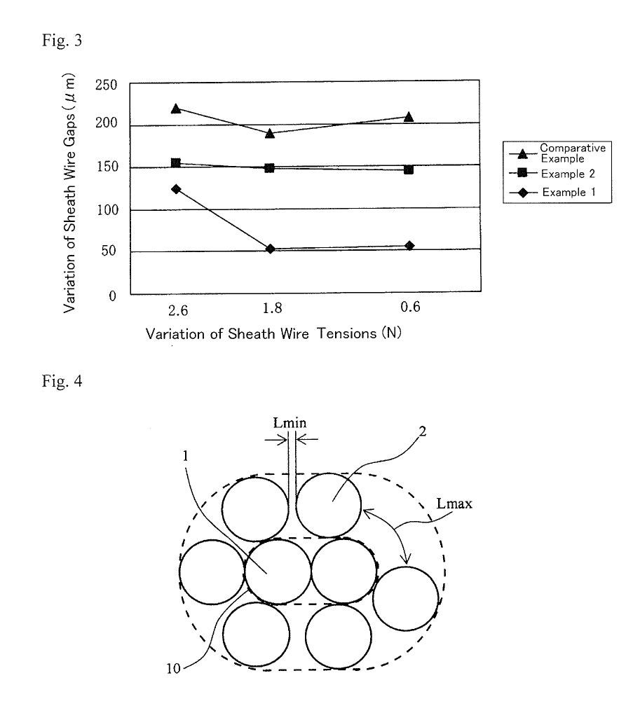

All of the sheath wire gaps (six points) for each of steel cords of Examples 1-1 to 2-3 and the Comparative Examples 1-1 to 1-3 were measured. The variation of the sheath wire gaps was calculated by the following formula with the obtained measured values. The relation between the tension of the sheath when being twisted and the variation of the sheath wire gaps is shown in FIG. 3. A schematic diagram of the variation of the sheath wire gaps is shown in FIG. 4.

(The variation of the sheath wire gaps)=(the maximum sheath wire gap Lₘₐₓ)−(the minimum sheath wire gap Lₘᵢₙ)

TABLE 1

| | | Core | Sheath | | | Rubber |
|---|---|---|---|---|---|---|
| | | Wire | Wire | | Sheath | Pene- |
| | Sheath | Diam- | Diam- | Sheath | Occu- | tration |
| | Tension | eter | eter | Gap ^{*1} | pancy | Property |
| | (N) | (mm) | (mm) | (μm) | ^{*2} (%) | (%) |
| Example 1-1 | 0.6 | 0.28 | 0.36 | 68 | 84 | 98 |
| Example 1-2 | 1.8 | 0.28 | 0.36 | 68 | 84 | 98 |
| Example 1-3 | 2.6 | 0.28 | 0.36 | 68 | 84 | 94 |
| Example 2-1 | 0.6 | 0.30 | 0.36 | 86 | 81 | 92 |
| Example 2-2 | 1.8 | 0.30 | 0.36 | 86 | 81 | 92 |
| Example 2-3 | 2.6 | 0.30 | 0.36 | 86 | 81 | 88 |
| Example 3 | 1.8 | 0.175 | 0.126 | 25 | 88 | 93 |
| Example 4 | 1.8 | 0.18 | 0.129 | 25 | 88 | 95 |
| Example 5 | 1.8 | 0.32 | 0.21 | 28 | 92 | 95 |
| Comparative | 0.6 | 0.32 | 0.36 | 103 | 78 | 55 |
| Example 1-1 | | | | | | |
| Comparative | 1.8 | 0.32 | 0.36 | 103 | 78 | 55 |
| Example 1-2 | | | | | | |
| Comparative | 2.6 | 0.32 | 0.36 | 103 | 78 | 48 |
| Example 1-3 | | | | | | |

^{*1} The average of the sheath wire gaps
^{*2} The sheath wire occupancy

From the Table 1, it is found that a favorable rubber penetration property can be obtained when the average of the sheath wire gaps and the sheath wire occupancy are in the range of the present invention.

FIG. 3 is a graph showing the relation between the tension applied to a sheath wire and the deviation of sheath wire gaps when the sheath wires were twisted in a steel cord manufacturing process. The higher the sheath wire occupancy is, the smaller the variation of the sheath wire gaps becomes. Even when the sheath wire occupancy is in a high level, the larger the variation of the tensions of the sheath wires when the steel wires are twisted is, the larger the variation of the sheath wire gaps becomes. In any tension conditions, the higher the sheath wire occupancy is, the smaller the variation becomes. That is, it is found that, in the steel cord of the present invention, even in the conditions that the variation of the tensions is large, the sheath wire gap is hard to deviate.

### DESCRIPTION OF SYMBOLS

1 core wire
2 sheath wire
10 core

1. A steel cord for reinforcing rubber articles composed of a core composed of two untwisted steel wires and six sheath wires which are twisted around the core, wherein
the average of gap distances between the adjacent sheath wires is 24 μm or larger, and the occupancy of the sheath wires disposed around the core with respect to a sheath wire disposition area is 80% or larger.

2. The steel cord for reinforcing rubber articles according to claim 1, wherein the occupancy of the sheath wire is 84% or larger.

3. A pneumatic tire which has, as a skeleton, a carcass extending toroidally between a pair of beads, and in which the crown portion of the carcass is reinforced by (a) belt layer(s), characterized in that
the steel cord for reinforcing rubber articles according to claim 1 is applied as a cord which constitutes the carcass and/or the belt layer(s).
